(19) United States
(12) Patent Application Publication
(10) Pub. No.: US 2010/0108011 A1
(43) Pub. Date: May 6, 2010

(54) INTAKE DEVICE FOR INTERNAL COMBUSTION ENGINES

(75) Inventors: Masayuki KATO, Toyota-shi (JP); Hiromitsu Ishihara, Okazaki-shi (JP)

Correspondence Address: BUCHANAN, INGERSOLL & ROONEY PC, POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 12/567,091

(22) Filed: Sep. 25, 2009

(30) Foreign Application Priority Data
Oct. 30, 2008 (JP) 2008-279993

(51) Int. Cl. F02M 35/104

(52) U.S. Cl. 123/184.56

(57) ABSTRACT

An intake device for internal combustion engines includes a casing, a shaft body rotatably supported on the casing, a valve element arranged in an intake passage of the casing, and an actuator that operatively turns the valve element through the shaft body. The shaft body includes plural outer peripheral surfaces, and is inserted through a hole in the valve element. A wall surface of the hole includes a first support region and a second support region supporting different outer peripheral surface portions of the shaft body. The first support region includes plural first wall surfaces, at least one of which is different in circumferential length than the remaining first wall surfaces. The second support region includes plural second wall surfaces, at least one of which is different in circumferential length than the remaining second wall surfaces.

### CROSS REFERENCE TO RELATED APPLICATION

This application is based on and claims priority under 35 U.S.C Section 119 to Japanese Patent Application No. 2008-279993 filed on Oct. 30, 2000, the entire content of which is incorporated herein by reference.

### BACKGROUND OF THE INVENTION

1. Field of the Invention

The present invention relates to an intake device for internal combustion engines, in which a force from an actuator is transmitted to a valve element latched on a shaft body through the shaft body to rotate the valve element.

2. Description of the Related Art

In such an intake device for internal combustion engines, a shaft body is inserted through and supported on a valve element to be able to rotate together therewith and the valve element is rotated by rotating the shaft body to control an intake flowrate. The related art involves a problem that a large frictional force is generated between a hole in a length direction of a valve element and a shaft body at the time of assembly to hinder a smooth assembling work since the hole and the valve element are substantially the same in cross sectional area.

Various examinations have been made in order to solve such problem. In, for example, a flow passage control valve device including a rotating shaft having a substantially uniform, non-circular cross sectional shape and a valve element mounted to the rotating shaft to interlock with rotation of the rotating shaft to open and close a flow passage, a fitting part is provided on the valve element to have the rotating shaft inserted therethrough and fitted thereonto and the fitting part includes first and second flat surfaces extending in an axial direction and being parallel to each other. Projections include first and second projections protruding from the first flat surface and a third projection protruding from the second flat surface, the third projection being arranged between the first projection and the second projection in the axial direction (see JP-A-2006-70720, paragraphs 0006-0008, FIGS. 3 and 4) .

With the flow passage control valve device in JP-A-2006-70720, the valve element has the fitting part, however, the valve element is made thin in thickness to lead to a decrease in strength. Also, the fitting part and the rotating shaft fit together to make an air flow turbulent, so that there is a fear that an engine or the like is decreased in performance.

Also, in order to form the hole provided not with a fitting part but with the projections as disclosed in JP-A-2006-70720 on the valve element, it is general to form the hole from hole defining members inserted from both ends in the length direction of the valve element. However, any space cannot be formed between the first projection and the second projection in a direction, in which formation is accomplished by the hole defining members, and so it is not possible to solve the problem described above.

### SUMMARY OF THE INVENTION

Thus, a need exists for an intake device for internal combustion engines, in which a frictional force is made small when a shaft body is inserted through a valve element and so the shaft body and the valve element can be firmly latched together, and which is not susceptible to the drawback mentioned above.

An aspect of the invention provides an intake device for internal combustion engines, including a casing formed with an intake passage, a shaft body supported on the casing to be able to rotate, a valve element latched on the shaft body and arranged in the intake passage, and an actuator that operatively turns the valve element through the shaft body, and wherein the shaft body includes a plurality of outer peripheral surfaces, the valve element is provided with a hole, through which the shaft body is inserted, the hole includes, on a wall surface thereof, a first support region, which covers the outer peripheral surfaces of the shaft body to support a partial surface of the plurality of outer peripheral surfaces of the shaft body, and a second support region, which covers the outer peripheral surfaces of the shaft body to support a partial surface out of the plurality of outer peripheral surfaces of the shaft body, which is not supported by the first support region, the first support region includes a plurality of first wall surfaces, at least one wall surface out of the plurality of first wall surfaces and the remaining wall surfaces out of the plurality of first wall surfaces being different in circumferential length from each other, and the second support region includes a plurality of second wall surfaces, at least one wall surface out of the plurality of second wall surfaces and the remaining wall surfaces out of the plurality of second wall surfaces being different in circumferential length from each other.

Another aspect of the invention provides an intake device for internal combustion engines, including a casing formed with an intake passage, a shaft body supported on the casing to be able to rotate, a valve element latched on the shaft body and arranged in the intake passage, and an actuator that operatively turns the valve element through the shaft body, and wherein the shaft body includes an outer peripheral surface in a circumferential direction of the shaft body, the valve element is provided with a hole, through which the shaft body is inserted, the hole includes, on a wall surface thereof, a first support region, which supports a part of the outer peripheral surface of the shaft body, and a second support region, which supports a part of the outer peripheral surface of the shaft body, which is not supported by the first support region, and the cross sectional shape of the first support region in a radial direction conforms with the cross sectional shape of the second support region in the radial direction when the second support region is rotated in the circumferential direction of the shaft body.

Still another aspect of the invention provides an intake device for internal combustion engines, including a casing formed with an intake passage, a shaft body supported on the casing to be able to rotate, a valve element latched on the shaft body and arranged in the intake passage, and an actuator that operatively turns the valve element through the shaft body, and wherein the shaft body includes an outer peripheral surface in a circumferential direction of the shaft body, the valve element is provided with a hole, through which the shaft body is inserted, the hole includes, on a wall surface thereof, a first support region, which supports a part of the outer peripheral surface of the shaft body, and a second support region, which supports a part of the outer peripheral surface of the shaft body, which is not supported by the first support region, and an outer peripheral line of the cross sectional shape of the first support region in a radial direction and an outer peripheral line of the cross sectional shape of the second support region in the radial direction include at least four intersection points as viewed in an axial direction of the hole.

Still another aspect of the invention provides an intake device for internal combustion engines, including a casing formed with an intake passage, a shaft body supported on the casing to be able to rotate, a valve element latched on the shaft body and arranged in the intake passage, and an actuator that operatively turns the valve element through the shaft body, and wherein the shaft body includes a first shaft portion on one side in an axial direction and a second shaft portion on the other side in the axial direction, the valve element is provided with a hole, through which the shaft body is inserted, the hole includes, on a plurality of wall surfaces thereof, a first support region, which covers the first shaft portion of the shaft body, and a second support region, which covers the second shaft portion of the shaft body, and an axis of the first support region and an axis of the second support region are eccentric relative to each other.

### BRIEF DESCRIPTION OF THE DRAWINGS

FIG. 1 is a view showing an example of an intake device according to the invention;

FIG. 2 is a view showing the example of an intake device according to the invention;

FIG. 3 is a view showing an example of a shaft body in an embodiment of an intake device according to the invention;

FIGS. 4A and 4B are perspective views showing a valve element in a first embodiment of an intake device according to the invention;

FIGS. 5A and 5B are views showing the shape of a support region in the first embodiment of an intake device according to the invention;

FIGS. 6A and 6B are perspective views showing a valve element in a second embodiment of an intake device according to the invention;

FIGS. 7A and 7B are views showing the shape of a support region in the second embodiment of an intake device according to the invention;

FIGS. 8A and 8B are perspective views showing a valve element in a third embodiment of an intake device according to the invention;

FIGS. 9A to 9C are views showing the shape of a support region in the third embodiment of an intake device according to the invention;

FIGS. 10A and 10B are perspective views showing a valve element in a fourth embodiment of an intake device according to the invention;

FIGS. 11A and 11B are views showing the shape of a support region in the fourth embodiment of an intake device according to the invention;

FIG. 12 is a view showing the cross sectional shape of the support region in a XII-XII direction in the fourth embodiment of an intake device according to the invention;

FIG. 13 is a view showing the cross sectional shape of the support region in the XII-XII direction in the case where movement inhibiting members are removed from the fourth embodiment of an intake device according to the invention;

FIG. 14 is a view showing an example of a shaft body in a fifth embodiment of an intake device according to the invention;

FIGS. 15A and 15B are perspective views showing a valve element in the fifth embodiment of an intake device according to the invention;

FIGS. 16A and 16B are views showing the shape of a support region in the fifth embodiment of an intake device according to the invention;

FIG. 17 is a view showing an example of a shaft body in a sixth embodiment of an intake device according to the invention;

FIGS. 18A and 18B are perspective views showing a valve element in the sixth embodiment of an intake device according to the invention;

FIGS. 19A and 19B are views showing the shape of a support region in the sixth embodiment of an intake device according to the invention;

FIG. 20 is a view showing the shape of a support region in the sixth embodiment of an intake device according to the invention; and

FIGS. 21A and 21B are views illustrating a method of forming a support region of a valve element in the invention.

### DESCRIPTION OF THE PREFERRED EMBODIMENTS

Embodiments of an intake device for internal combustion engines, according to the invention, will be described below with reference to the drawings.

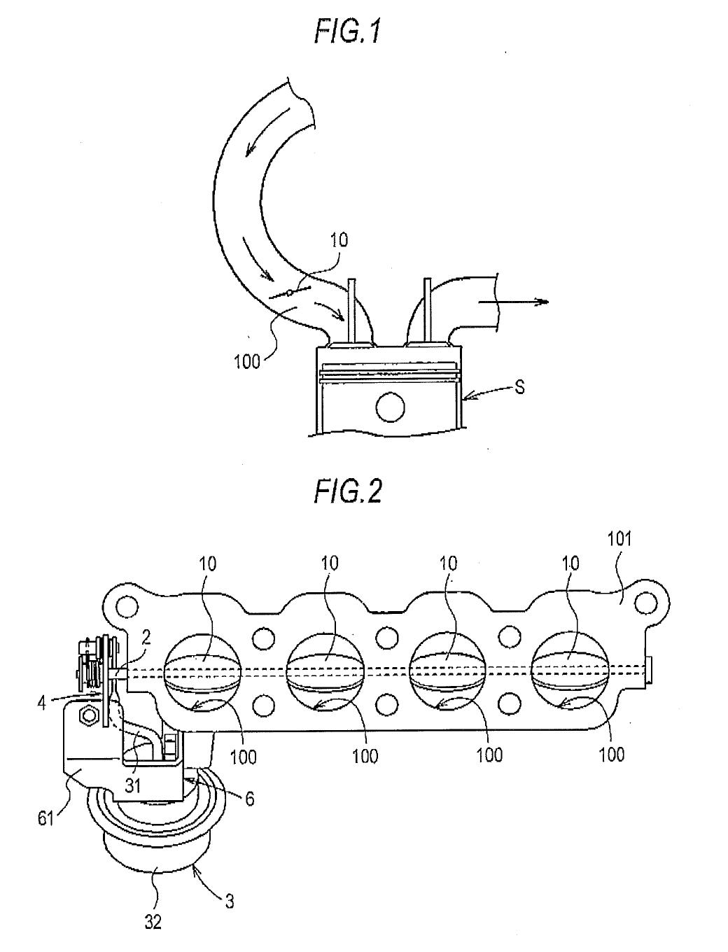

FIGS. 1 and 2 show an example, in which an intake device for internal combustion engines, according to the invention, is applied to an intake device for adjustment of the flow velocity of an air supplied to an in-line four-cylinder engine. The intake device includes an intake manifold including a plurality (four in the embodiment) of intake pipes (an example of an intake passage in the invention) 100. One ends of the respective intake pipes 100 are connected to cylinders S, respectively. Also, variable intake valves (an example of a valve element in the invention) 10 are pivotally provided in the respective intake pipes 100 in the vicinity of the cylinders S. With the intake device, the variable intake valves 10 are turned to vary the intake pipes 100 in cross sectional area to adjust the flow velocity of an air flowing in the intake pipes 100 whereby the engine is improved in combustion efficiency.

Turning of the variable intake valves 10 is materialized by turning of a shaft body 2 inserted through the variable intake valves 10. The shaft body 2 is arranged in a direction perpendicular to the intake pipes 100 of the intake manifold to be inserted into and pivotally supported in a bearing hole formed in the vicinity of a flange part 101 of the intake manifold.

One end of the shaft body 2 projects from a side of the intake manifold. The projecting portion and an actuator rod 31 are connected to each other through a link member 4. Specifically, the link member 4 is provided with a first hole portion, through which the shaft body 2 can be inserted, and the projecting portion of the shaft body 2 is inserted through the first hole portion to be able to turn together. Also, a pivot shaft provided at a tip end of the actuator rod 31 is inserted through a second hole portion provided on the link member 4 whereby the actuator rod 31 and the link member 4 are pivotally connected to be able to turn relative to each other. Thereby, protruding/retreating movements of the actuator rod 31 are transmitted as turning movements to the shaft body 2 through the link member 4.

Further, another end of the actuator rod 31, at which the pivot shaft is not provided, is connected to an actuator 3. The actuator rod 31, can produce protruding/retreating movements as the actuator 3 acts.

The actuator 3 is supported on an outer periphery of the intake manifold through a bracket 6 including a first wall portion 61, to which the actuator 3 is mounted, and a second wall portion provided upright on the first wall portion 61.

For example, a diaphragm type actuator can be used for the actuator 3. However, this is not limitative but use of an actuator of a further type will do. The actuator 3 includes an actuator body 32 and the actuator rod 31 described above.

An interior of the actuator body 32 is compartmented into an atmospheric pressure chamber (not shown) and a negative pressure chamber (not shown) by a diaphragm (not shown), the diaphragm being biased toward the atmospheric pressure chamber.

One end of the actuator rod 31 is connected to the diaphragm. A negative pressure is applied in the negative pressure chamber whereby the actuator rod 31 actuates to retreat toward the actuator body 32. Also, application of a negative pressure in the negative pressure chamber is released whereby the actuator rod 31 actuates to protrude from the actuator body 32.

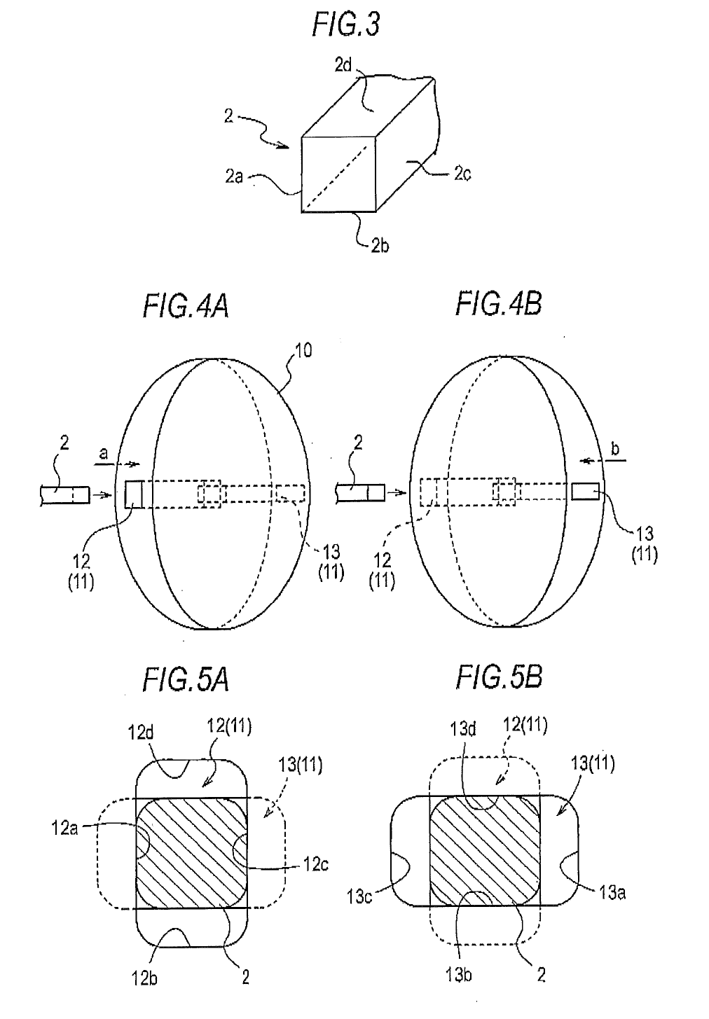

As described above, the shaft body 2 is inserted through the variable intake valves 10 and as the shaft body 2 turns, the variable intake valves 10 are turned. Therefore, as shown in FIG. 3 or the like, the variable intake valves 10 are provided with holes 11, through which the shaft body 2 is inserted. The holes 11 include a plurality of support regions. The support regions can be configured in a various manner. Preferred embodiments will be shown below.

### First Embodiment

A first embodiment of an intake device for internal combustion engines, according to the invention, will be described below with reference to FIGS. 4A to 5B. In addition, a shaft body 2 in the embodiment is substantially square-shaped in cross section in a radial direction as shown in FIG. 3 to include outer peripheral surfaces 2a, 2b, 2c, 2d in parallel to an axis. According to the embodiment, holes 11 include a first support region 12 and a second support region 13, which are aligned in an axial direction. The first support region 12 and the second support region 13 include wall surfaces 12a to 12d (a first wall surface in the invention) and 13a to 13d (a second wall surface in the invention), which are in parallel to the outer peripheral surfaces 2a to 2d of the shaft body 2.

FIG. 5A is a view showing the holes 11 as viewed in a a direction in FIG. 4A when the shaft body 2 is inserted through the holes 11. FIG. 5B is a view showing the holes 11 as viewed in a b direction in FIG. 48. In FIGS. 5A and 5B, the cross section of the shaft body 2 is indicated by hatching (this is the same with the following embodiments). As apparent from FIGS. 5A and 5B, the cross sectional shape of the first support region 12 in a radial direction conforms with the cross sectional shape of the second support region 13 in the radial direction when the second support region 13 is rotated 90 degrees in a circumferential direction. With the first support region 12, the wall surfaces 12a and 12c support the outer peripheral surfaces 2a and 2c of the shaft body 2. On the other hand, the wall surfaces 12b and 12d are not in contact with the outer peripheral surfaces of the shaft body 2. Also, with the second support region 13, the wall surfaces 13b and 13d support the outer peripheral surfaces 2b and 2d of the shaft body 2 and the wall surfaces 13a and 13c are not in contact with the outer peripheral surfaces of the shaft body 2.

According to the embodiment, the holes 11 are formed in this manner whereby two respective surfaces opposed to each other with an axis therebetween in the first support region 12 and in the second support region 13 support the outer peripheral surfaces of the shaft body 2 when the shaft body 2 is inserted through the holes 11. Therefore, frictional forces between the wall surfaces of the holes 11 and the shaft body 2 decrease to enable smooth insertion of the shaft body 2. Also, the wall surfaces 12a and 12c in the first support region 12 and the wall surfaces 13b and 13d in the second support region 13 support different outer peripheral surfaces of the shaft body 2. Therefore, as a whole, the holes 11 support all the outer peripheral surfaces of the shaft body 2, so that it is possible to firmly latch the shaft body 2 and the variable intake valves 10 together.

### Second Embodiment

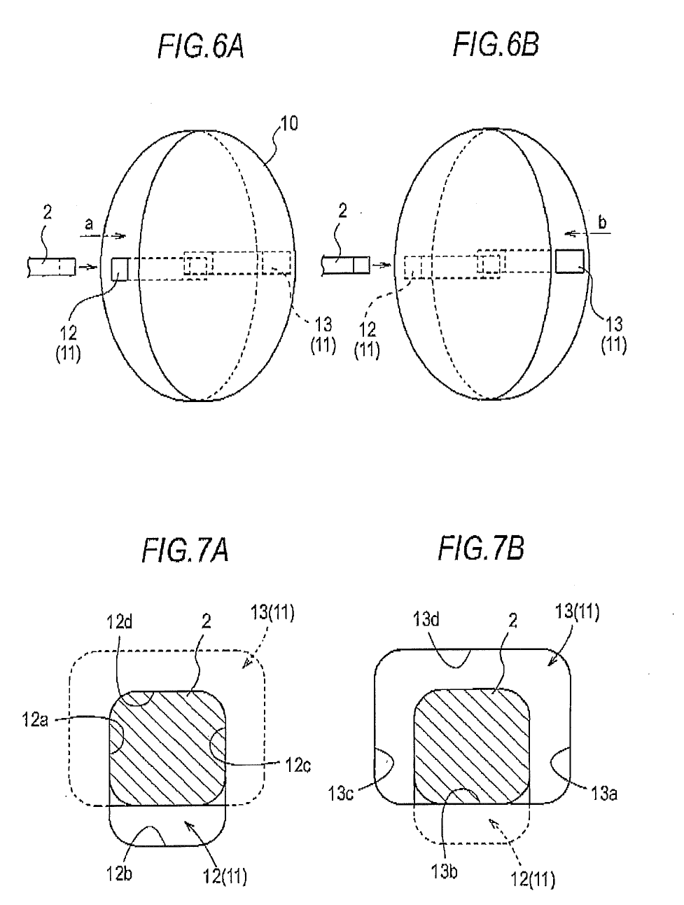

A second embodiment of an intake device for internal combustion engines, according to the invention, will be described below with reference to FIGS. 6A to 7B. Like the first embodiment, the embodiment uses the shaft body 2 shown in FIG. 3. Also, holes 11 include a first support region 12 and a second support region 13, which are aligned in an axial direction, the first support region 12 and the second support region 13 including wall surfaces 12a to 12d (a first wall surface in the invention) and 13a to 13d (a second wall surface in the invention), which are in parallel to outer peripheral surfaces of the shaft body 2.

FIG. 7A is a view showing the holes 11 as viewed in a a direction in FIGS. 6A and 6B when the shaft body 2 is inserted through the holes 11. FIG. 7B is a view showing the holes 11 as viewed in a b direction in FIGS. 6A and 6B. According to the embodiment, as apparent from FIGS. 7A and 7B, the wall surface 12a is the same in circumferential length as the wall surface 12c but different from the wall surfaces 12b and 12d. Also, the wall surface 13a is the same in circumferential length as the wall surface 13c but different from the wall surfaces 13b and 13d. Further, the cross sectional shape of the first support region 12 in a radial direction and the cross sectional shape of the second support region 13 in the radial direction are eccentric relative to each other. At this time, a portion of the shaft body 2 covered by the first support region 12 constitutes a first shaft portion and a portion of the shaft body 2 covered by the second support region 13 constitutes a second shaft portion.

Also, as apparent from FIGS. 7A and 7B, with the first support region 12, the wall surfaces 12a, 12c, and 12d support the outer peripheral surfaces 2a, 2c, and 2d of the shaft body 2, and the wall surface 12b is not in contact with the outer peripheral surfaces of the shaft body 2. On the other hand, with the second support region 13, the wall surface 13b supports the outer peripheral surface 2b of the shaft body 2, and the wall surfaces 13a, 13c, and 13d are not in contact with the outer peripheral surfaces of the shaft body 2.

In this manner, it is possible to provide for a construction, in which the number of those wall surfaces, which support the outer peripheral surfaces of the shaft body 2, is different among the respective support regions. With such construction, the respective support regions include those wall surfaces, which are not in contact with the outer peripheral surfaces of the shaft body 2 when the shaft body 2 is inserted through the holes 11. Therefore, smooth insertion of the shaft body 2 can be accomplished as compared with the related art. Also, those outer peripheral surfaces of the shaft body 2, which are supported by the wall surfaces of the first support region 12, and those outer peripheral surfaces of the shaft body 2, which are supported by the wall surfaces of the second support region 13, are different from each other. Accordingly, as a whole, the holes 11 support all the outer peripheral surfaces of the shaft body 2, so that it is possible to firmly latch the shaft body 2 and the variable intake valves 10 together.

### Third Embodiment

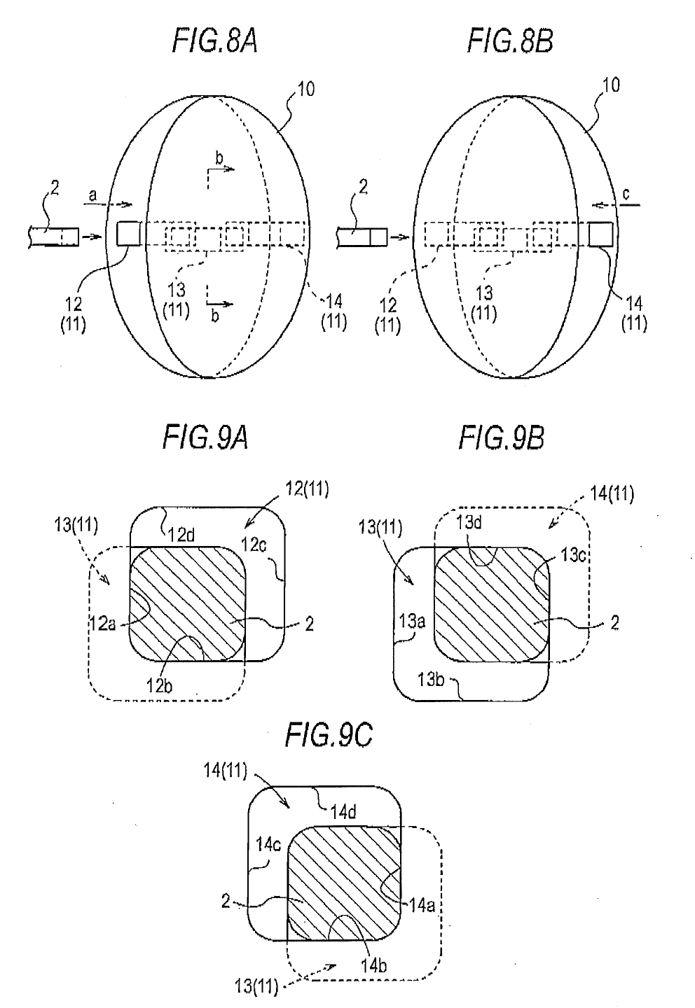

A third embodiment of an intake device for internal combustion engines, according to the invention, will be described below with reference to FIGS. 8A to 9C. Like the first embodiment, the embodiment uses the shaft body 2 shown in FIG. 3. Also, holes 11 include three support regions being adjacent in an axial direction of the holes 11, that is, a first support region 12, a second support region 13, and a first support region 14 in this order in the axial direction. The respective support regions include wall surfaces 12a to 12d, 13a to 13d, and 14a to 14d. In addition, according to the embodiment, the first support region 12, the second support region 13, and the first support region 14, respectively, are adjacent in the axial direction but a configuration, in which the support regions adjoin, will do. That is, it does not matter if those regions, in which the shaft body 2 is not supported, are present between the first support region 12 and the second support region 13 and between the second support region 13 and the first support region 14.

FIG. 9A is a view showing the holes 11 as viewed in a a direction in FIGS. 8A and 8B when the shaft body 2 is inserted through the holes 11. FIG. 9B is a view showing the holes 11 when cross sections taken along the line b-b in FIG. 8A are viewed in a b direction and represents a cross sectional view showing the second support region 13. FIG. 9C is a view showing the holes 11 as viewed in a c direction in FIG. 8B.

According to the embodiment, as apparent from FIGS. 9A to 9C, the cross sectional shape of the first support region 12 in a radial direction and the cross sectional shape of the second support region 13 in the radial direction are eccentric relative to each other. On the other hand, the cross sectional shape of the second support region 13 in the radial direction and the cross sectional shape of the first support region 14 in the radial direction are eccentric relative to each other. On the other hand, the cross sectional shape of the first support region 12 in the radial direction and the cross sectional shape of the first support region 14 in the radial direction have the same axis. At this time, a portion of the shaft body 2 covered by the first support region 12 and a portion of the shaft body 2 covered by the first support region 14 constitute a first shaft portion, and a portion of the shaft body 2 covered by the second support region 13 constitutes a second shaft portion.

Also, as apparent from FIGS. 9A to 9C, with the first support region 12, the wall surfaces 12a and 12b support outer peripheral surfaces 2a and 2b of the shaft body 2, and the wall surfaces 12c and 12d are not in contact with outer peripheral surfaces of the shaft body 2. On the other hand, with the second support region 13, the wall surfaces 13c and 13d support outer peripheral surface 2c and 2d of the shaft body 2, and the wall surfaces 13a and 13b are not in contact with outer peripheral surfaces of the shaft body 2. On the other hand, with the first support region 14, the wall surfaces 14a and 14b support the outer peripheral surfaces 2a and 2b of the shaft body 2, and the wall surfaces 14c and 14d are not in contact with outer peripheral surfaces of the shaft body 2.

In this manner, according to the embodiment, the cross sectional shapes of the respective support regions in the radial direction are eccentric relative to each other whereby two wall surfaces being adjacent in a circumferential direction support two outer peripheral surfaces of the shaft body 2 in the respective support regions. Thereby, it is possible to reduce a frictional force when the shaft body 2 is inserted. Also, there are provided the two first support regions, between which the second support region is arranged, thereby enabling preventing the shaft body 2 from jolting and enabling firmly latching the shaft body 2 and the variable intake valves 10 together.

### Fourth Embodiment

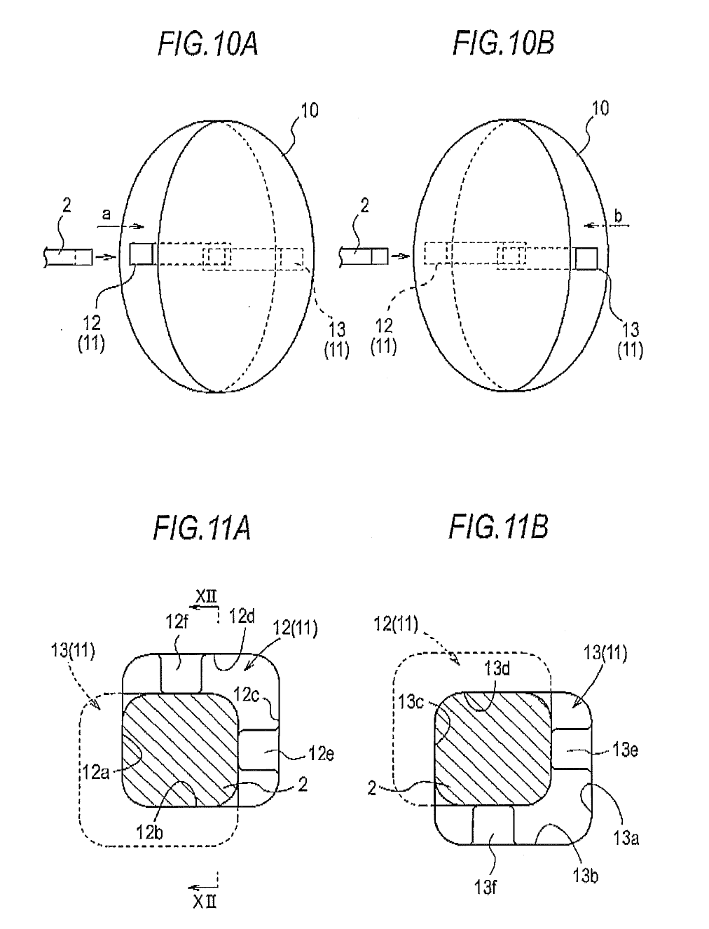

A fourth embodiment of an intake device for internal combustion engines, according to the invention, will be described below with reference to FIGS. 10A to 11B. Like the embodiments described above, the embodiment uses the shaft body 2 shown in FIG. 3. Also, in the same manner as in the third embodiment, the cross sectional shape of a first support region 12 in a radial direction and the cross sectional shape of a second support region 13 in the radial direction are eccentric relative to each other. However, a difference from the third embodiment resides in that holes 11 include the first support region 12 and the second support region 13.

FIG. 11A is a view showing the holes 11 as viewed in a a direction in FIG. 10A when the shaft body 2 is inserted through the holes 11. FIG. 11B is a view showing the holes 11 as viewed in a b direction in FIG. 10B. According to the embodiment, as apparent from FIGS. 11A and 11B, with the first support region 12, wall surfaces 12a and 12b support outer peripheral surfaces 2a and 2b of the shaft body 2, and wall surfaces 12c and 12d are not in contact with the outer peripheral surfaces of the shaft body 2. On the other hand, with the second support region 13, wall surfaces 13c and 13d support outer peripheral surfaces 2c and 2d of the shaft body 2, and wall surfaces 13a and 13b are not in contact with the outer peripheral surfaces of the shaft body 2.

Also, out of the wall surfaces of the respective support regions, a wall surface opposed to that surface, which supports the outer peripheral surfaces of the shaft body 2, with an axis therebetween, is provided with a movement inhibiting member, which inhibits the shaft body 2 from moving in a direction away from the wall surfaces, by which the shaft body 2 is supported. In FIGS. 11A and 11B, the wall surfaces 12a and 12b of the first support region 12 support the outer peripheral surfaces 2a and 2b of the shaft body 2, and the wall surfaces 12c and 12d opposed to the wall surfaces 12a and 12b are provided with movement inhibiting members 12e and 12f, which are rib-shaped to extend in an axial direction of the holes 11. On the other hand, the wall surfaces 13c and 13d of the second support region 13 support the outer peripheral surfaces 2c and 2d of the shaft body 2, and the wall surfaces 13a and 13b opposed to the wall surfaces 13c and 13d are provided with movement inhibiting members 13e and 13f.

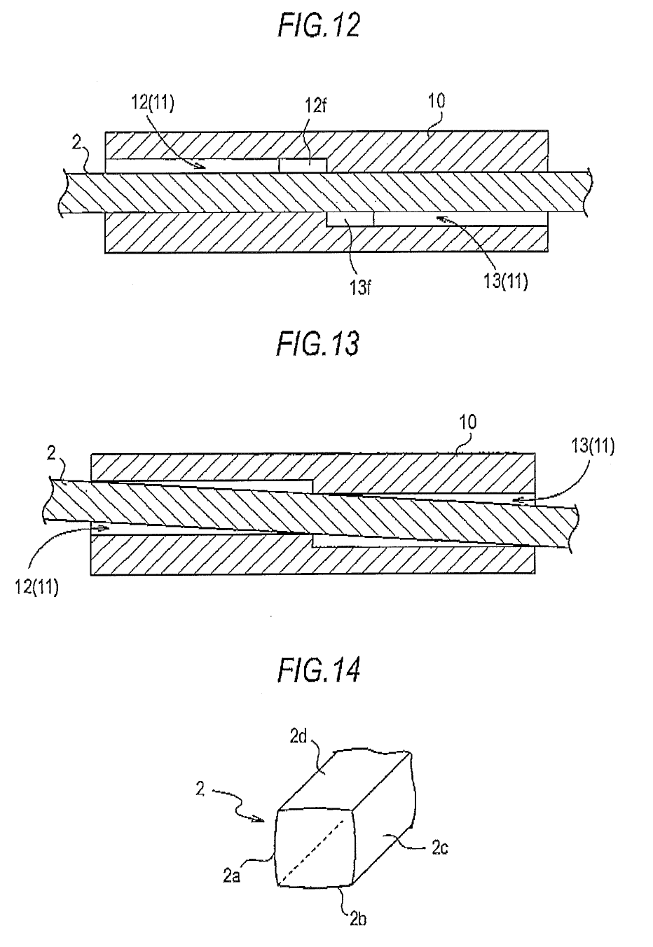

FIG. 12 shows the holes 11 as viewed from a cross section along the line in FIGS. 11A and 11B. FIG. 13 shows the construction of the embodiment with the movement inhibiting members removed. As apparent from FIG. 13, with the construction of the embodiment, the shaft body 2 is movable in a direction away from the respective wall surfaces. Therefore, the shaft body 2 jolts to be responsible for a functional decrease in the intake device.

On the other hand, with the embodiment, in which the movement inhibiting members are provided, the wall surfaces of the respective support regions and the movement inhibiting members make it possible to inhibit the shaft body 2 from jolting and to firmly latch the shaft body 2 and the variable intake valves 10 together.

In addition, the movement inhibiting members (12f, etc.) can be appropriately changed in length taking account of a frictional force at the time of insertion, a force, with which the shaft body 2 and the variable intake valves 10 are latched on each other, or the like. Also, the movement inhibiting members (12f, etc.) can be appropriately changed positionally. When the movement inhibiting members are arranged in positions in contact with surfaces adjacent to the first support region 12 and the second support region 13 as shown in FIG. 12, however, the support regions are readily and preferably formed.

In addition, according to the embodiment, the movement inhibiting members are provided on all the wall surfaces opposed to those wall surfaces, which support the outer peripheral surfaces of the shaft body 2, but a configuration, in which the movement inhibiting members are provided only on a part of the wall surfaces, will do. Also, the movement inhibiting members are provided in all the support regions, but a configuration, in which they are provided only in a part of the support regions, will do. In this manner, the movement inhibiting members can be appropriately changed in arrangement as far as they are provided on the wall surfaces opposed to those wall surfaces, which support the outer peripheral surfaces of the shaft body 2, to attain an object of the invention.

### Fifth Embodiment

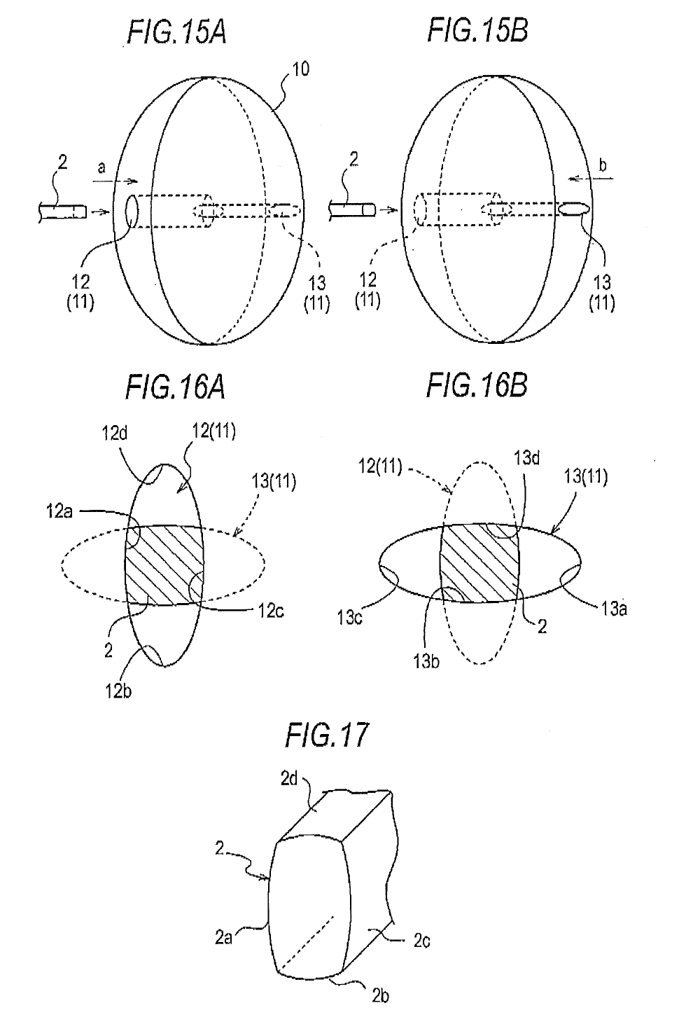

A fifth embodiment of an intake device for internal combustion engines, according to the invention, will be described below with reference to FIGS. 15A to 16B. In addition, a shaft body 2 in the embodiment includes outer peripheral surfaces 2a to 2d being curvilinear in cross section in a radial direction as shown in FIG. 14. According to the embodiment, in the same manner as in the first embodiment, holes 11 include a first support region 12 and a second support region 13, which are aligned in an axial direction. Also, the first support region 12 and the second support region 13, respectively, include wall surfaces, which are curved (according to the embodiment, the support regions are elliptical in cross sectional shape in a radial direction).

FIG. 16A is a view showing the holes 11 as viewed in a a direction in FIG. 15A when the shaft body 2 is inserted through the holes 11. FIG. 16B is a view showing the holes 11 as viewed in a b direction in FIG. 15B. As apparent from FIGS. 16A and 16B, the cross sectional shape of the first support region 12 in a radial direction conforms with the cross sectional shape of the second support region 13 in the radial direction when the second support region 13 is rotated 90 degrees in a circumferential direction. With the first support region 12, portions (referred below to as partial wall surfaces) 12a and 12c of wall surfaces support outer peripheral surfaces 2a and 2c of the shaft body 2. On the other hand, partial wall surfaces 12b and 12d between the partial wall surfaces 12a and 12c are not in contact with the outer peripheral surfaces of the shaft body 2. Also, with the second support region 13, partial wall surfaces 13b and 13d support outer peripheral surfaces 2b and 2d of the shaft body 2 and partial wall surfaces 13a and 13c between the partial wall surfaces 13b and 13d are not in contact with the outer peripheral surfaces of the shaft body 2.

According to the embodiment, the holes 11 are formed in this manner whereby two respective surfaces opposed to each other with an axis of the holes 11 therebetween in the first support region 12 and in the second support region 13 support the outer peripheral surfaces of the shaft body 2 when the shaft body 2 is inserted through the holes 11. Therefore, frictional forces between the wall surfaces of the holes 11 and the shaft body 2 decrease to enable smooth insertion of the shaft body 2. Also, the wall surfaces 12a and 12c in the first support region 12 and the wall surfaces 13b and 13d in the second support region 13 support different outer peripheral surfaces of the shaft body 2. Therefore, as a whole, the holes 11 support all the outer peripheral surfaces of the shaft body 2, so that it is possible to firmly latch the shaft body 2 and the variable intake valves 10 together. Further, a configuration, in which an outer peripheral line of a cross sectional shape of the shaft body 2 in a radial direction is increased in curvature and an area, in which the shaft body 2 and the wall surfaces of the support regions contact with each other, is decreased, is preferable since a frictional force at the time of insertion is further decreased.

### Sixth Embodiment

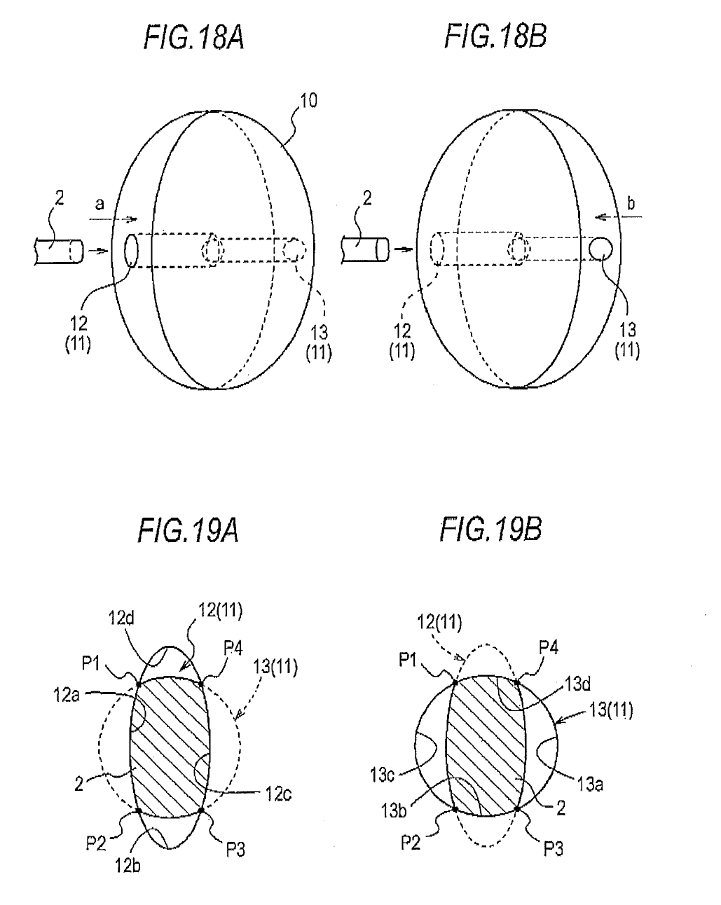

A sixth embodiment of an intake device for internal combustion engines, according to the invention, will be described below with reference to FIGS. 18A to 19B. In addition, a shaft body 2 in the embodiment includes outer peripheral surfaces 2a to 2d being curvilinear in cross section in a radial direction as shown in FIG. 17. According to the embodiment, in the same manner as in the first embodiment, holes 11 include a first support region 12 and a second support region 13, which are aligned in an axial direction. Also, the first support region 12 and the second support region 13, respectively, include wall surfaces, which are curved (according to the embodiment, the first support region 12 is elliptical and the second support region 13 is circular).

FIG. 19A is a view showing the holes 11 as viewed in a a direction in FIG. 18A when the shaft body 2 is inserted through the holes 11. FIG. 19B is a view showing the holes 11 as viewed in a b direction in FIG. 18B. As apparent from FIGS. 19A and 19B, an outer peripheral line of a cross sectional shape of the first support region 12 in a radial direction and an outer peripheral line of a cross sectional shape of the second support region 13 in the radial direction include four intersection points P1 to P4 as viewed in the axial direction. With the first support region 12 partial wall surfaces 12a and 12c support outer peripheral surfaces 2a and 2c of the shaft body 2. On the other hand, partial wall surfaces 12b and 12d between the partial wall surfaces 12a and 12c are not in contact with the outer peripheral surfaces of the shaft body 2. Also, with the second support region 13, partial wall surfaces 13b and 13d support outer peripheral surfaces 2b and 2d of the shaft body 2 and partial wall surfaces 13a and 13c between the partial wall surfaces 13b and 13d are not in contact with the outer peripheral surfaces of the shaft body 2.

In this manner, even when the cross sectional shape of the first support region 12 in a radial direction and the cross sectional shape of the second support region 13 in the radial direction are made different from each other, the holes 11 are formed so that both the cross sectional shapes include four intersection points P1 to P4 as viewed in the axial direction, whereby two respective surfaces opposed to each other with an axis of the holes 11 therebetween in the first support region 12 and in the second support region 13 support the outer peripheral surfaces of the shaft body 2 when the shaft body 2 is inserted through the holes 11. Therefore, frictional forces between the wall surfaces of the holes 11 and the shaft body 2 decrease to enable smooth insertion of the shaft body 2. Also, the wall surfaces 12a and 12c in the first support region 12 and the wall surfaces 13b and 13d in the second support region 13 support different outer peripheral surfaces of the shaft body 2. Therefore, as a whole, the holes 11 support all the outer peripheral surfaces of the shaft body 2, so that it is possible to firmly latch the shaft body 2 and the variable intake valves 10 together.

In addition, intersection points of an outer peripheral line of the cross sectional shape of the first support region 12 in the radial direction and an outer peripheral line of the cross sectional shape of the second support region 13 in the radial direction are not limited to four in number as viewed in the axial direction. For example, as shown in FIG. 20, the cross sectional shape of the first support region 12 in the radial direction is made an equilateral, upper triangle and the cross sectional shape of the second support region 13 in the radial direction is made an equilateral, lower triangle whereby intersection points (P1 to P6) of outer peripheral lines of the cross sectional shapes can be made six in number. In addition, in this case, as apparent from a hatched portion in FIG. 20, the cross sectional shape of the shaft body 2 in the radial direction becomes an equilateral triangle. Also, three wall surfaces of the first support region 12 support three outer peripheral surfaces of the shaft body 2 and three wall surfaces of the second support region 13 support three outer peripheral surfaces of the shaft body 2. In this manner, when the intersection points are at least four (finite) in number, it is possible to latch the shaft body 2 and the variable intake valves 10 together, so that intersection points of an outer peripheral line of the cross sectional shape of the first support region 12 in the radial direction and an outer peripheral line of the cross sectional shape of the second support region 13 in the radial direction can be appropriately changed in number according to cross sectional shapes of support regions in the radial direction,

### [Method of Forming a Support Region]

Subsequently, an explanation will be given to a method of forming a support region of a variable intake valve 10 in an intake device for internal combustion engines, according to the invention. In addition, a method of forming the first support region 12 and the second support region 13 in the fourth embodiment will be described herein.

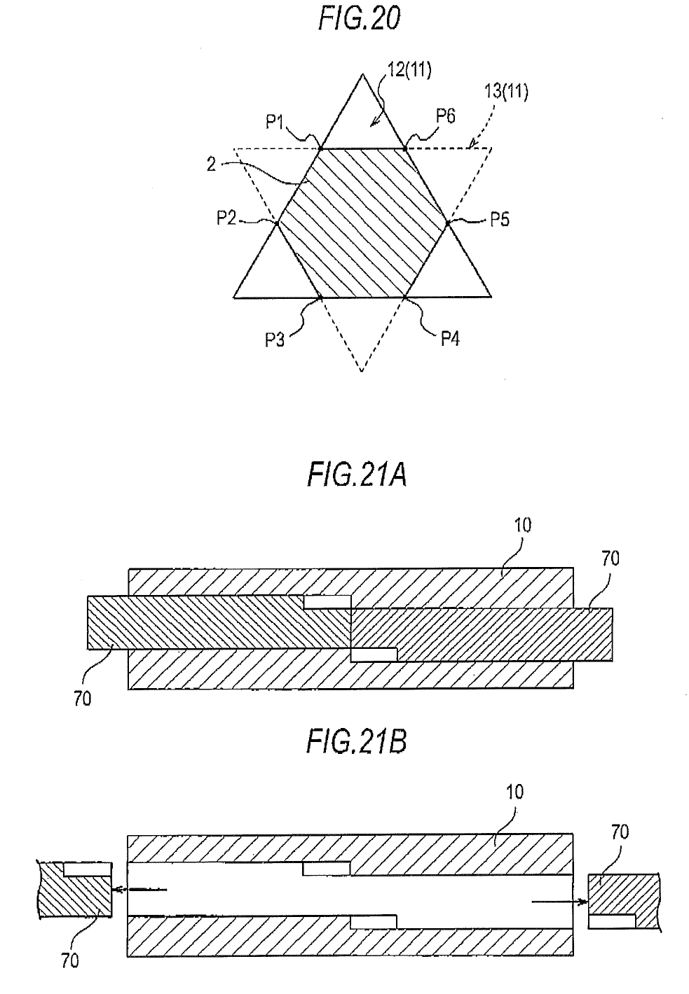

Ordinarily, the variable intake valve 10 can be produced by pouring a resin material into a mold. At this time, support-region forming members 70 being the same in shape as the respective support regions are inserted from both ends of holes 11 in an axial direction (FIG. 21A) and the support-region forming members 70 are pulled out when the resin solidifies, whereby the first support region 12 and the second support region 13 can be readily formed (FIG. 21B). In this example, by providing recesses, which correspond in shape to the movement inhibiting members 12f, 13f, or the like, in the first support region 12 and the second support region 13, it is possible to form the movement inhibiting members 12f, 13f, or the like integrally and simultaneously with the first support region 12 and the second support region 13.

According to one embodiment of the invention, the hole provided on the valve element includes a first support region, which supports a partial surface out of the plurality of outer peripheral surfaces of the shaft body, and a second support region, which supports a partial surface out of the plurality of outer peripheral surfaces of the shaft body, which is not supported by the first support region. Therefore, the outer peripheral surface of the shaft body is not supported as a whole in either of the support regions, and when the shaft body is inserted through the hole of the valve element, a frictional force between the wall surface of the hole and the outer peripheral surface of the shaft body is decreased to enable smooth insertion of the shaft body. Also, the first support region includes the plurality of first wall surfaces, at least one wall surface out of the plurality of first wall surfaces and the remaining wall surfaces out of the plurality of first wall surfaces being different in circumferential length from each other, and the second support region includes the plurality of second wall surfaces, at least one wall surface out of the plurality of second wall surfaces and the remaining wall surfaces out of the plurality of second wall surfaces being different in circumferential length from each other, so that it is possible to readily form the first support region and the second support region.

According to one embodiment of the invention, the hole provided on the valve element includes a first support region, which supports a part of the outer peripheral surface of the shaft body, and a second support region, which supports a part of the outer peripheral surface of the shaft body, which is not supported by the first support region. Therefore, the outer peripheral surface of the shaft body is not supported as a whole in either of the support regions, and when the shaft body is inserted through the hole of the valve element, a frictional force between the wall surface of the hole and the outer peripheral surface of the shaft body is decreased to enable smooth insertion of the shaft body. Also, since the cross sectional shape of the first support region in a radial direction conforms with the cross sectional shape of the second support region in the radial direction when the second support region is rotated in the circumferential direction of the shaft body, it is possible to readily form the first support region and the second support region.

According to one embodiment of the invention, the hole provided on the valve element includes a first support region, which supports a part of the outer peripheral surface of the shaft body, and a second support region, which supports a part of the outer peripheral surface of the shaft body, which is not supported by the first support region. Therefore, the outer peripheral surface of the shaft body is not supported as a whole in either of the support regions, and when the shaft body is inserted through the hole of the valve element, a frictional force between the wall surface of the hole and the outer peripheral surface of the shaft body is decreased to enable smooth insertion of the shaft body. Also, since an outer peripheral line of the cross sectional shape of the first support region in a radial direction and an outer peripheral line of the cross sectional shape of the second support region in the radial direction include at least four intersection points as viewed in an axial direction of the hole, it is possible to readily form the first support region and the second support region.

According to one embodiment of the invention, the shaft body includes a first shaft portion on one side in an axial direction and a second shaft portion on the other side in the axial direction, the hole provided on the valve element includes a first support region, which covers the first shaft portion of the shaft body, and a second support region, which covers the second shaft portion of the shaft body, and an axis of the first support region and an axis of the second support region are eccentric relative to each other. Therefore, a partial surface out of an outer peripheral surface of a shaft is supported in the first support region and a portion of the outer peripheral surface of the shaft, which is not supported in the first support region, is supported in the second support region. Thereby, the outer peripheral surface of the shaft body is not supported as a whole in either of the support regions, and when the shaft body is inserted through the hole of the valve element, a frictional force between the wall surface of the hole and the outer peripheral surface of the shaft body is decreased to enable smooth insertion of the shaft body.

According to one embodiment of the invention, two of the first supporting portions are provided, thereby enabling preventing the shaft body from jolting and enabling firmly latching the shaft body and the valve element together.

According to one embodiment of the invention, the shaft body can be prevented from jolting and the shaft body and the valve element can be firmly latched together.

What is claimed is:

1. An intake device for internal combustion engines, comprising:
a casing formed with an intake passage;
a shaft body supported on the casing to be able to rotate;
a valve element latched on the shaft body and arranged in the intake passage; and
an actuator that operatively turns the valve element through the shaft body,
wherein the shaft body includes a plurality of outer peripheral surfaces,
the valve element is provided with a hole, through which the shaft body is inserted,
the hole includes, on a wall surface thereof, a first support region, which covers the outer peripheral surfaces of the shaft body to support a partial surface out of the plurality of outer peripheral surfaces of the shaft body, and a second support region, which covers the outer peripheral surfaces of the shaft body to support a partial surface out of the plurality of outer peripheral surfaces of the shaft body, which is not supported by the first support region,
the first support region includes a plurality of first wall surfaces, at least one wall surface out of the plurality of first wall surfaces and the remaining wall surfaces out of the plurality of first wall surfaces being different in circumferential length from each other, and
the second support region includes a plurality of second wall surfaces, at least one wall surface out of the plurality of second wall surfaces and the remaining wall surfaces out of the plurality of second wall surfaces being different in circumferential length from each other.

2. An intake device for internal combustion engines, comprising:
a casing formed with an intake passage;
a shaft body supported on the casing to be able to rotate,
a valve element latched on the shaft body and arranged in the intake passage; and
an actuator that operatively turns the valve element through the shaft body,
wherein the shaft body includes an outer peripheral surface in a circumferential direction of the shaft body,
the valve element is provided with a hole, through the which shaft body is inserted,
the hole includes, on a wall surface thereof, a first support region, which supports a part of the outer peripheral surface of the shaft body, and a second support region, which supports a part of the outer peripheral surface of the shaft body, which is not supported by the first support region, and
the cross sectional shape of the first support region in a radial direction conforms with the cross sectional shape of the second support region in the radial direction when the second support region is rotated in the circumferential direction of the shaft body.

3. An intake device for internal combustion engines, comprising:
a casing formed with an intake passage;
a shaft body supported on the casing to be able to rotate,
a valve element latched on the shaft body and arranged in the intake passage; and
an actuator that operatively turns the valve element through the shaft body,
wherein the shaft body includes an outer peripheral surface in a circumferential direction of the shaft body,
the valve element is provided with a hole, through which the shaft body is inserted,
the hole includes, on a wall surface thereof, a first support region, which supports a part of the outer peripheral surface of the shaft body, and a second support region, which supports a part of the outer peripheral surface of the shaft body, which is not supported by the first support region, and
an outer peripheral line of the cross sectional shape of the first support region in a radial direction and an outer peripheral line of the cross sectional shape of the second support region in the radial direction include at least four intersection points as viewed in an axial direction of the hole.

4. An intake device for internal combustion engines, comprising:
a casing formed with an intake passage;
a shaft body supported on the casing to be able to rotate,
a valve element latched on the shaft body and arranged in the intake passage; and
an actuator that operatively turns the valve element through the shaft body,
wherein the shaft body includes a first shaft portion and a second shaft portion, which are aligned in an axial direction,
the valve element is provided with a hole, through which the shaft body is inserted,
the hole includes, on a plurality of wall surfaces thereof, a first support region, which covers the first shaft portion of the shaft body, and a second support region, which covers the second shaft portion of the shaft body, and
an axis of the first support region and an axis of the second support region are eccentric relative to each other.

5. The intake device for internal combustion engines according to claim 4, wherein the shaft body comprises two of the first shaft portions and the second shaft portion positioned between the first shaft portions in an axial direction, and
the hole comprises, on a plurality of wall surfaces thereof, two of the first support regions and the second support region positioned between the first support regions in an axial direction.

6. The intake device for internal combustion engines according to claim 4, wherein at least one wall surface out of the wall surfaces at least one of the first support region and the second support region, opposed to that wall surface with an axis of the hole therebetween, which supports an outer peripheral surface of the shaft body, is provided with a movement inhibiting member, which inhibits the shaft body from moving in a direction away from that wall surface, which supports the shaft body.

7. The intake device for internal combustion engines according to claim 1, wherein the shaft body is inhibited from moving in a direction away from the wall surfaces which supports the shaft body.

8. The intake device for internal combustion engines according to claim 2, wherein the shaft body is inhibited from moving in a direction away from the wall surfaces which supports the shaft body.

9. The intake device for internal combustion engines according to claim 3, wherein the shaft body is inhibited from moving in a direction away from the wall surfaces which supports the shaft body.

10. The intake device for internal combustion engines according to claim 4, wherein the shaft body is inhibited from moving in a direction away from the wall surfaces which supports the shaft body.

11. The intake device for internal combustion engines according to claim 5, wherein the shaft body is inhibited from moving in a direction away from the wall surfaces which supports the shaft body.
